(19) United States
(12) Patent Application Publication
(10) Pub. No.: US 2023/0029558 A1
(43) Pub. Date: Feb. 2, 2023

(54) INFORMATION PROCESSING DEVICE, INFORMATION PROCESSING SYSTEM, INFORMATION PROCESSING METHOD, AND STORAGE MEDIUM

(71) Applicant: KONICA MINOLTA, INC., Tokyo (JP)

(72) Inventor: Takashi KUWABARA, Osaka (JP)

(73) Assignee: KONICA MINOLTA, INC., Tokyo (JP)

(21) Appl. No.: 17/869,047

(22) Filed: Jul. 20, 2022

(30) Foreign Application Priority Data
Jul. 30, 2021 (JP) 2021-125415

(51) Int. Cl. G06F 16/28; G06F 16/25

(52) U.S. Cl. CPC G06F 16/285; G06F 16/258

(57) ABSTRACT

An information processing unit includes a hardware processor. The hardware processor extracts a plurality of features related to a content of acquired first data, analyzes a co-occurrence relationship between the extracted plurality of features, and generates a group related to the plurality of features based on the co-occurrence relationship.

### CROSS-REFERENCE TO RELATED APPLICATIONS

The entire disclosure of Japanese Patent Application No. 2021125415 filed on Jul. 30, 2021 is incorporated herein by reference in its entirety.

### BACKGROUND

### Technological Field

The invention relates to an information processing device, an information processing system, an information processing method, and a storage medium.

### Description of the Related Art

In recent years, a lot of digital information has been integrated, and management and use thereof have become important. When these types of information are properly classified, the information can be easily searched and referenced. However, for data of which format such as document data in natural language is not fixed, there is a problem in that it is difficult to determine a group for appropriately classifying the contents for classification. In addition, even if the manager or the like determines an appropriate group once, in some cases, the specified group may change inappropriately according to the contents of the documents accumulated after that. Therefore, there is a need to organize these groups and continuously determine and update the groups many times.

On the other hand, there is a technique to automatically generate a group (cluster, community) by grouping the contents of digital information by machine learning without a teacher. JP 2002-41544 A discloses a technique of using both a technique for automatically classifying text data based on a combination of terms in a text of a classification target and a technique for classifying the text data into a predetermined group to know whether the classification is performed properly by comparing the classification results by the two techniques.

### SUMMARY

However, in the related art, it is necessary to determine in advance the number of groups of classification destinations even when classification is automatically performed. In other words, it is not possible to estimate in advance how many groups need to be divided into to properly categorize a large amount of data, and thus, there is a problem in that it becomes necessary for users and persons in charge to repeat adjustments and perform trial and error, and thus, this technique is not efficient.

The invention is to provide an information processing device, an information processing system, an information processing method, and a storage medium capable of easily knowing the number of groups suitable for classifying data.

To achieve at least one of the abovementioned objects, according to an aspect of the present invention, there is provided an information processing device including: a hardware processor that: extracts a plurality of features related to a content of acquired first data; analyzes a co-occurrence relationship between the plurality of features; and generates a group related to the plurality of features based on the co-occurrence relationship.

To achieve at least one of the abovementioned objects, according to an aspect of the present invention, there is provided an information processing system including: one or more hardware processors, one of the one or more hardware processors extracting a plurality of features related to a content of acquired first data, one of the one or more hardware processors analyzing a co-occurrence relationship between the extracted plurality of features, and one of the one or more hardware processors generating a group of the plurality of features based on the co-occurrence relationship.

To achieve at least one of the abovementioned objects, according to an aspect of the present invention, there is provided an information processing method including: extracting a plurality of features related to a content of acquired first data; analyzing a co-occurrence relationship between the plurality of features; and generating a group related to the plurality of features based on the co-occurrence relationship.

To achieve at least one of the abovementioned objects, according to an aspect of the present invention, there is provided a non-transitory storage medium storing a computer readable program, the program causing a computer to execute functions of extracting a plurality of features related to a content of acquired first data; analyzing a co-occurrence relationship between the plurality of features; and generating a group related to the plurality of features based on the co-occurrence relationship.

### BRIEF DESCRIPTION OF THE DRAWINGS

The advantages and features provided by one or inure embodiments of the invention will become more fully understood from the detailed description given hereinbelow and the appended drawings which are given by way of illustration only, and thus are not intended as a definition of the limits of the present invention, wherein:

FIG. 1 is a block diagram illustrating a functional configuration of an information processing device of an embodiment.

FIG. 2 is a diagram illustrating a flow of processes by a CPU.

FIG. 3A is a diagram illustrating a node and an edge.

FIG. 3B is a diagram illustrating a node and an edge.

FIG. 4 is a flowchart illustrating a control procedure of an analysis data acquisition control process.

FIG. 5 is a flowchart illustrating a control procedure of a co-occurrence analysis control process.

FIG. 6 is a flowchart illustrating a control procedure of a group detection control process.

### DETAILED DESCRIPTION OF THE EMBODIMENTS

Hereinafter, embodiments of the invention will be described with reference to the drawings. However, the scope of the invention is not limited to the embodiments disclosed below.

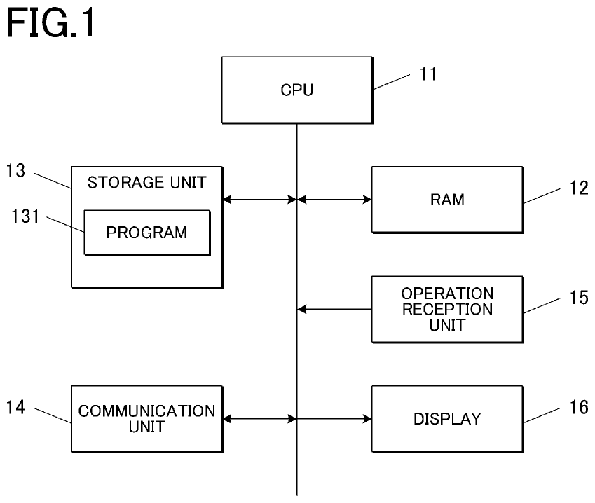

FIG. 1 is a block diagram illustrating a functional configuration of an information processing devices of an embodiment.

The information processing device 1 is, for example, a normal personal computer (PC) and configured to include a central processing unit (CPU) 11 (an extractor (segmenter), an analyzer, a generator, a converter, an output unit, and an output data generator), a random access memory (RAM) 12, a storage unit 13 (storage), a communication unit 14, an operation reception unit 15, a display 16, and the like.

The CPU 11 is a hardware processor that performs arithmetic processes and controls operations of the information processing device 1 in an integrated manner. The CPU 11 may be a single one, or a plurality of the CPUs 11 may perform the arithmetic processes in parallel. Further, the plurality of CPUs may be assigned to each according to a function or the like and may perform calculations independently.

The RAM 12 provides the CPU 11 with a working memory space and stores temporary data. The RAM 12 is, for example, a DRAM and can read and write a large amount of data at a high speed. The stored temporary data may include data, which is an analysis target or a classification target, which is acquired via the communication unit 14 and the like.

The storage unit 13 is a non-volatile storage medium and, for example, a flash memory, a hard disk drive (HDD), or the like. The storage unit 13 stores a program 131 executed by the CPU 11 and various types of setting data. The storage unit 13 may not be embedded in the information processing device 1 or may be an external device. Further, the storage unit 13 may be located on a network such as a cloud server.

The communication unit 14 controls transmission/reception of data between the information processing device 1 and the outside according to a predetermined communication reference. The communication reference is not particularly limited, but includes, for example, TCP/IP related to a local area network (LAN). Further, in addition to or instead of the TCP/IP, the communication unit 14 may be capable of performing communication control related to wireless communication such as WiFi. In addition, the communication unit 14 may have it driver controlling one-to-one communication such as a universal serial bus (USB).

The operation reception unit 15 receives an input operation from the outside, generates an input signal corresponding to the input operation, and outputs the input signal to the CPU 11. The operation reception unit 15 has, for example, a keyboard, various types of pointing devices, and the like. Further, the operation reception unit 15 may include various types of switching elements such as a power supply switch and a reset switch, and in addition to or in place of these switching elements, may include a touch panel or the like that is located so as to overlap a display screen of the display 16.

The display 16 has the display screen and performs a display operation on the display screen based on the control of the CPU 11. The display screen is, for example, a liquid crystal display, and various types of characters and figures can be displayed. Further, the display 16 may have an LED lamp or the like indicating whether or not power is supplied and whether or not there is access to the storage unit 13.

The information processing device 1 may not have the operation reception unit 15 and/or the display 16, but may perform receiving the input operation (command) and transmitting display data by access from the outside via the communication unit 14.

Further, although it is described herein that a single information processing device 1 performs all processes, there may be employed an information processing system in which CPUs 11 are distributed and arranged on a plurality of computers to execute each process while appropriately transmitting and receiving data.

Next, an operation of acquiring the number of groups in the information processing device 1 will be described.

Various machine learning models are proposed for classification of data that is made of a text document expressed in natural language and can include audio data and image data that can be converted into the text document (explanatory document, or the like). However, in the machine learning model, even if a user or the like defines a category in advance and assigns each data to the category, when a group (cluster or community) is automatically generated (clustering) and each data is assigned. If the number of groups is not appropriately determined in advance, there may occur a problem in that, for example, the number of groups to be classified is insufficient, and a group occurs in which a plurality of types of topics are not properly separated but mixed.

In addition, with respect to information expressed in language, since a topic often changes over time, a tendency of classification criteria and the number of groups also change. Therefore, it takes a lot of time and effort for a data manager or the like to appropriately update the number of groups and the classification criteria repetitively according to the change.

In the information processing device 1 according to the embodiment, the number of groups (number of clusters) for appropriately classifying the acquired data of the classification target is obtained and output. The data of the classification target is not particularly limited, but normally includes a large number of (a plurality of) documents. Each document includes one or a plurality of sentences. A document including a plurality of sentences may be partitioned by a plurality of paragraphs, sections, chapters, units, and the like. In addition, when the data of the classification target includes data that is not text data (non-text data), the non-text data is converted into text and segmented into morphemes. The classification is performed based on an appearance situation of these morphemes.

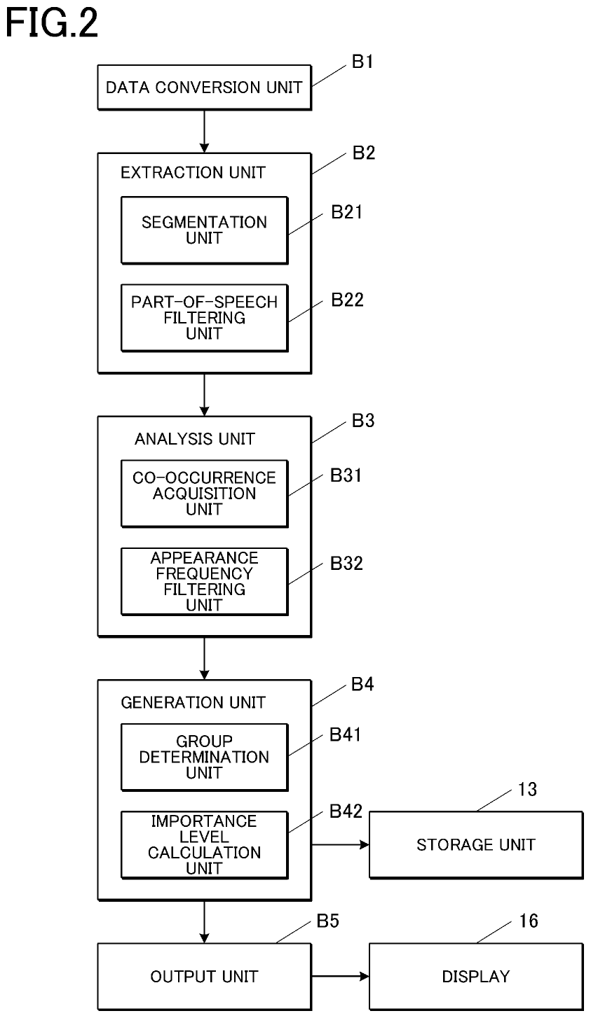

FIG. 2 is a diagram illustrating a flow of processes by the CPU 11.

The processes are divided into a data conversion unit B1, an extraction unit B2, an analysis unit B3, a generation unit B4, and an output unit B5. Each of these units is classified for convenience of explanation, and is not intended to have a difference in hardware configuration (may include classification or the like in terms of a program). For example, all the processes may be performed by the single CPU 11, or a process may be appropriately assigned to the CPU having a relatively small load and a sufficient computing performance among the plurality of CPUs 11 regardless of the contents of each unit.

The data conversion unit B1 as a converter extracts features loom input data (first data) and converts into the text data (second data) in a unified format (predetermined format) suitable (possible) for analysis. The data conversion unit B1 converts, for example, audio data into text by a well-known audio recognition algorithm, or converts image data of a document into text by a well-known optical character recognition (OCR) algorithm. Further, the data conversion unit B1 may be able to convert the image data or the like into an explanatory text or the like. When the input data is text data from the beginning, the data conversion unit B1 may output data as it is without performing, the conversion process (identical conversion), or may omit inputting/outputting from/to the data conversion unit B1.

Furthermore, the extraction unit B2 as an extractor (extraction step) includes a segmentation unit B21 and a part-of-speech filtering, unit B22. The segmentation unit B21 as a segmenter morpheme-analyzes the input text data to segment the input text data into morphemes (a plurality of features related to the contents of the input data). Herein, morphemes are synonymous with words, but the morphemes are not limited thereto. The segmentation unit B21 specifies the parts of speech of each of the segmented morphemes. As a well-known method for a morpheme analysis algorithm for Japanese text, for example, McCab, JUMAN, KyTea, ChaSen, and the like are known, and an appropriate method may be selected and used. The part-of-speech filtering unit B22 filters and extracts only a specific type of part of speech (at least a portion), for example, a noun among the segmented morphemes. The nouns include proper nouns. As topics corresponding to groups (herein, morphemes), the correspondence of nouns is the highest, and the correspondence of auxiliary verbs is low. Verbs, adjectives, or the like need not to be excluded, but if the document has a certain length, these verbs, adjectives, or the like are not added to the topic for dividing into groups, and can correspond to the group of topics with appropriate accuracy,

For the remaining morphemes (that is, nouns) filtered by the extraction unit B2, the appearance frequency (first appearance frequency) for each predetermined range, for example, for each predetermined number (one or two or more) of sentences, for each one paragraph, or for each document (divided data) is obtained. In addition, the appearance frequencies are summed up for the entire data (that is, a large number of documents) to obtain the total appearance frequency of each morpheme. The obtained appearance frequency of each morpheme and the total appearance frequency are stored and retained in the RAM 12. The calculation of the total appearance frequency may be included in the process of an analysis unit B3 as described later.

Next, the analysis unit B3 as an analyzer (analysis step) includes a co-occurrence acquisition unit B31 and an appearance frequency filtering unit B32. The co-occurrence acquisition unit B31 analyzes the co-occurrence relationship within each predetermined range. The co-occurrence acquisition unit B31 refers to the data of the appearance situation of a plurality of morphemes in each predetermined range stored in the RAM 12, and a combination of the morphemes that appear simultaneously (are in a co-occurrence relationship) within the predetermined range and the number thereof (co-occurrence frequency (second appearance frequency)) are acquired. That is, when there is a set of morphemes (nouns) appearing simultaneously within a predetermined range, the smaller value of the appearance frequency of the two morphemes forming the set is the co-occurrence frequency within this range. By simply adding the co-occurrence frequencies of each range obtained in this manner for each set, the total co-occurrence frequency (strength of the co-occurrence relationship) of each morpheme set in the data can be obtained.

The appearance frequency filtering unit B32 filters a set of morphemes of which the total appearance frequency of each morpheme (noun) is within a reference range and or which the total co-occurrence frequency is equal to or higher than a threshold value and extracts the set of morphemes as an analysis target. Since the morphemes having too high a total appearance frequency are often general terms and tend to appear regardless of the field and contents of the group, such morphemes are not useful for determination of group. On the other hand, special morphemes having a low total appearance frequency are not sufficient to determine the correspondence with each group. Therefore, the appearance frequency filtering unit B32 extracts only the morphemes of which the total appearance frequency is equal to or higher than a reference lower limit value and equal to or lower than a reference upper limit value. The reference lower limit value is, for example, the average value of the appearance frequencies of all the morphemes. The reference upper limit value can be defined relative to a maximum total appearance frequency of all morphemes (for example, 4/5 of the maximum total appearance frequency).

In addition, since a group having an extremely low co-occurrence frequency (for example, a group having a total co-occurrence frequency of 1 time (that is, a threshold value is two times as a minimum reference)) has a small influence on the determination of group, and thus, such group is also excluded to reduce the load of the process described later.

Furthermore, as an index for evaluating the degree of aggregation of the sets of co-occurrence morphemes, herein, a Simpson coefficient Rs is calculated. The Simpson coefficient Rs is an index indicating a ratio of the total co-occurrence frequency to a value of the morpheme having a small total appearance frequency among the two morphemes of the co-occurring set (Rs=|(A and B)|/min (|A|, |B|), A is an aggregation of one morpheme, B is an aggregation of the other morpheme, (A and B) is an aggregation of co-occurrence states of both morphemes, and |x| represents the appearance frequency of the aggregation x). That is, when all the morphemes having the Lower appearance frequency appear within the same range (same sentence) as the morphemes having the higher appearance frequency, the Simpson coefficient Rs becomes 1 at the maximum. When the Simpson coefficient Rs is low, for example, less than 0.2 (Rs=0.2 is the minimum reference), it is considered that a plurality of morphemes appear in the same sentence incidentally without correlation (this situation occurs mainly when the appearance frequency of both morphemes is high), such morphemes are excluded.

As described above, the appearance frequency filtering unit B32 excludes morphemes of which appearance frequency of the morpheme and co-occurrence frequency with other morphemes are difficult to be used or are useless for group determination.

As an index, another well-known index of the Simpson coefficient for example, a Jaccard coefficient, a Dice coefficient, or the like may be used or used in combination.

As described above, after morphemes and a list of morpheme set suitable for group determination and the appearance frequencies thereof are extracted, the generation unit B4 as a generator (generation step) performs group generation and additional processes based on the above co-occurrence relationship. The generation unit B4 includes a group determination unit B41 and an importance level calculation unit B42.

The group determination unit B41 determines the sparseness and denseness of the morpheme connection (distribution of the strength of the co-occurrence relationship) based on the set of morphemes having the co-occurrence relationship obtained as described above and the total co-occurrence frequency thereof and defines the group so that the dense portion according to the degree of aggregation is grouped and the group is segmented in the sparse portion. Any one of the well-known methods can be used for determining such a group, and although it is not particularly limited, for example, a Louvain method is preferably used.

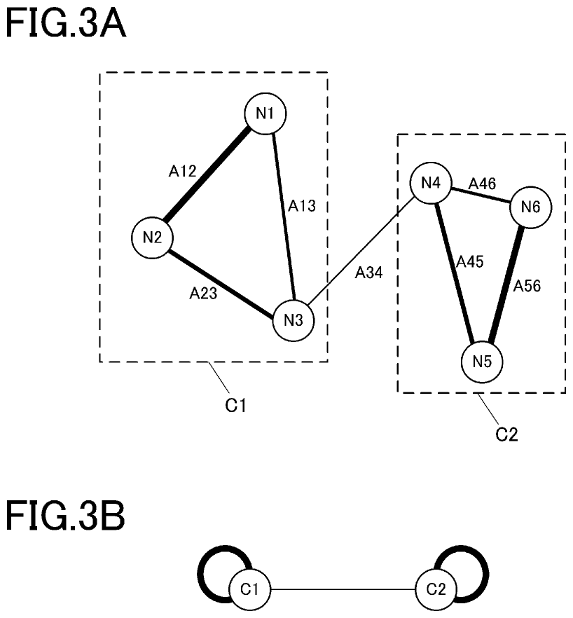

Each extracted morpheme is used as a node N, and the size (weight) of the edge A, which is the connection between the i-th node Ni and the j-th node Nj, is represented by the total co-occurrence frequency Aij. FIGS. 3A and 3B are diagrams illustrating these nodes N and edges A.

As illustrated in FIG. 3A, seven edges A are illustrated leer the six nodes N1 to N6. Nodes N of which edges are not illustrated are not in the co-occurrence relationship (total co-occurrence frequency is zero). The thickness of the edge A schematically illustrates the total co-occurrence frequency Aij.

The sum ki of the total co-occurrence frequencies Aix of the plurality of lines of edges A coupled to each node Ni (one end thereof is in the node Ni) is expressed as ki=Σ₍ₓ₎Aix. Further, the total obtained by adding the sums ki related to all the nodes Ni is 2 m=Σ₍ᵢ₎ki. The two edges A12 and A13 coupled to the node N1 connect the node N1 with the nodes N2 and N3, respectively, and thus, the sum ki=A12+A13. Since the total co-occurrence frequency for one edge A is repetitively included in the sums ki and kj for the nodes Ni and Nj at both ends, a half (m) of the total 2 m is a sum of total co-occurrence frequencies of all the edges A.

As can be clearly seen from FIG. 3A, the nodes N1 to N3 are strongly coupled by the three edges A (respective total co-occurrence frequencies are A12, A13, and A23), and the nodes N4 to N6 are strongly coupled by the three edges A (respective total co-occurrence frequencies are A45, A46, and A56). Since there is only one thin edge A (total co-occurrence frequency is A34) between these two groups, the nodes N1 to N6 can be preferably segmented into the group C1 (cluster) including the nodes N1 to N3 and the group C2 including the nodes N4 to N6.

As an index that comprehensively expresses the strength of the coupling within the groups C1 and C2 and the weakness of the coupling between the groups (a predetermined index for evaluating a quality of an aggregation), there is modularity Q=(1/(2m)·Σ_{(i,j)}{Aij−kj·kj/(2m)}·δ(Ci, Cj). δ is a Kronecker detta, which is 1 when the group Ci to which the node Ni belongs and the group Cj to which the node Nj belongs are the same and 0 when the groups Ci and Cj are different. As expressed by the first term of the equation, a value obtained by adding only the total co-occurrence frequencies in the same group among the total co-occurrence frequencies Aij and dividing by 2 m becomes larger as the number of couplings in the group increases. In the examples of FIGS. 3A and 3B, the value is twice the sum of the total co-occurrence frequencies A12, A23, and A13.

On the other hand, Σᵢ(ki/(2m)) is a ratio of the sum of the total co-occurrence frequency Aix of the edge A connected to the node Ni with respect to the total 2 m. By further summing this for the node Ni belonging to the group Ci, the probability that one end of the edge A is in the group Ci (equal to the expected value due to the normalization) is illustrated. This probability is a value including the case where the other end of the edge A is not in the group Ci. Σᵢ(ki·kj)/(2 m)·δ(Ci, Cj) is a probability that both ends of the, edge A are in the node Ni belonging to the group Ci. That is, the modularity Q indicates the actual degree of bias (cohesion) with respect to the average probability that both ends belong to the group Ci when the ends of the average defined edge A are arbitrarily sl connected, and it is illustrated that, as the value is larger, the bias is larger, and the, edges A are connected in the group Ci.

In the Louvain method, each node Nr (r is any of node numbers 1 to n) is affiliated to each individual group C to calculate the modularity Q, and then, when the group C to which each node Nr is affiliated is changed (integrated), the validity of the change (integration) is determined based on the increase and decrease in the modularity Q, so that the grouping is optimized. That is, when there is no change in the group C of the node Nr that increases the modularity Q (when locally maximized), the grouping setting becomes final group setting. The optimization referred to herein is local maximization in a certain range of the modularity Q and cannot be stated to exactly coincide with the maximization. However, when the local maximization and the maximum obtained at a certain ratio coincide with each other, the local maximization is included in the optimization herein.

In this case, the change in the modularity Q may be calculated for all the groups adjacent to the node Nr rich is an affiliation change target, and the calculation for the, group not affected by the change may be omitted.

In some cases, the, process may not be totally optimized only by optimizing each node Nr once. After optimizing, each node Nr once, as illustrated in FIG. 3B, each group is integrated and the graph is reconstructed, and each integrated group is used as a node to determine whether or not the node belongs to the upper group again. The overall optimization ends when the modularity Q does not increase even though the group is further unified.

The number of groups obtained by setting the group optimized in this manner becomes a candidate for an appropriate number of groups and is output by the output unit B5 as an output unit. At this time, not only the number but also the important node N in each group segmented together, that is, the information of the morpheme can be extracted as reference information to the user (operation as an output data generator). The extraction of important nodes N is represented by a well-known index (importance level) related to various types of centrality, for example, mediation centrality. The mediation centrality is determined by the number (ratio) of sets of nodes located on the shortest path when connecting arbitrary sets of nodes via edges in a group (relationship of features),

An output destination by the output unit BS is illustrated herein as the display 16, but may be, for example, an external device (other electronic device) or a peripheral device (printer or the like) via the communication unit 14. Further, the above result obtained by the generation unit B4 may be stored by the storage unit 13. By storing the results at each timing for the data of which amount of data is increasing cumulatively, it is possible to indicate the change situation of the results in several times of outputs.

Each process illustrated in FIG. 2 does not necessarily have to be executed in serial order, and may be performed back and forth or in parallel for each portion.

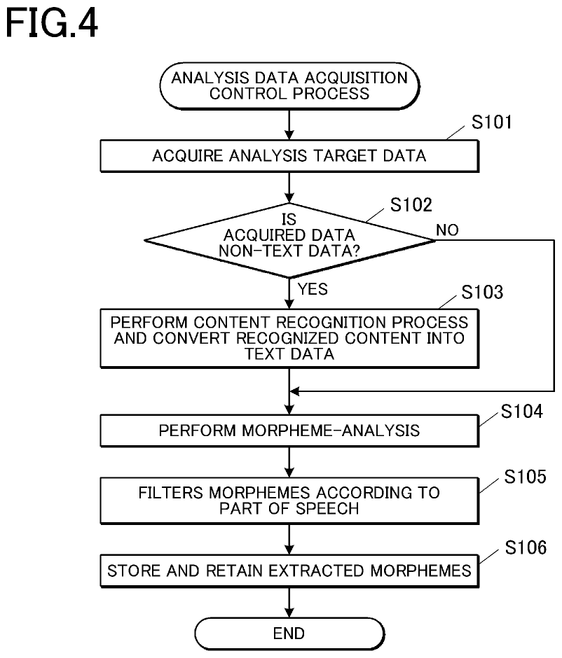

FIG. 4 is a flowchart illustrating a control procedure by the CPU 11 of the analysis data acquisition control process executed by the information processing device 1. This analysis data acquisition control process corresponds to the process contents of the data conversion unit B1 and the extraction unit B2 described above.

When the analysis data acquisition control process starts, the CPU 11 acquires analysis target data (step S101). As described above, the analysis target data includes a large amount of document data and the like and is acquired from an external data server or the like via the communication unit 14.

The CPU 11 determines whether or not the acquired data is non-text data (step S102). When the data is determined to be non-text data (“YES” in step S102), the CPU 11 performs a content recognition process and converts the recognized content into text data (step S103). Then, the converted data is transmitted to the process of step S104. When the data is determined not to be non-text data (determined to be text data) (“NO” in step S102), the CPU 11 transmits the data as it is to the process of step S104.

When the process proceeds to the process of step S104, the CPU 11 morpheme-analyzes the text data in a predetermined range, for example, for each sentence, and decomposes the text data into morphemes, herein, words (parts of speech) (step S104). The CPU 11 specifies the part of speech of each word obtained by decomposition. The CPU 11 filters each decomposed morpheme (word) according to the part of speech (step S105). Herein, the CPU 11 extracts only nouns. The nouns include proper nouns. The CPU 11 may treat the noun and the proper noun as different parts of speech, and may perform a process of extracting the nouns and the proper nouns.

The CPU 11 stores and retains the extracted morpheme (noun) in the RAM 12 for each predetermined range (step S106). Since information such as the order of appearance is unnecessary, the CPU 11 may sort the storage order as necessary. For the morphemes that appear a plurality of times, the number of times of appearance is also stored.

The processes of steps S104 to S106 are repeated until the processes for all the predetermined ranges (sentences) in the text data is completed. Then, the CPU 11 ends the analysis data acquisition control process.

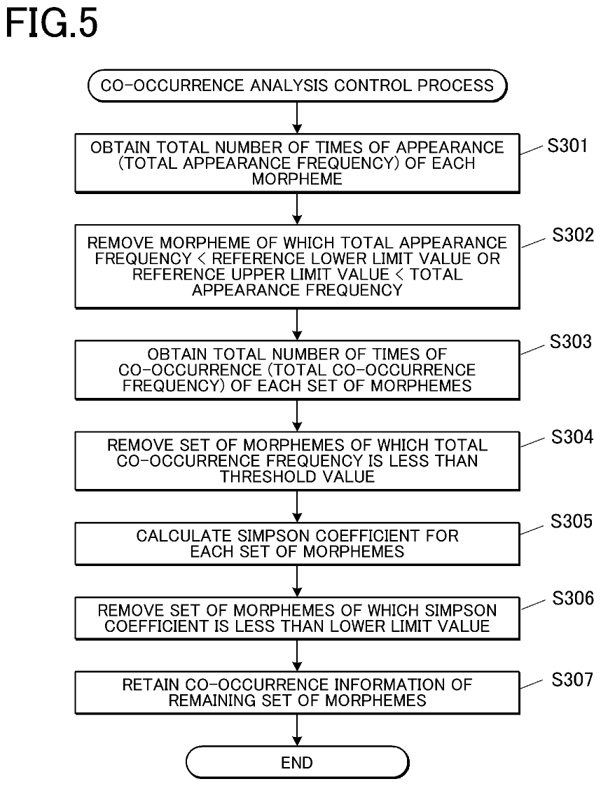

FIG. 5 is a flowchart illustrating a control procedure of the co-occurrence analysis control process by the CPU 11. This co-occurrence analysis control process corresponds to the process content of the analysis unit B3 and starts after the analysis data acquisition control process ends.

When the co-occurrence analysis control process starts, the CPU 11 obtains the total number of times of appearance (total appearance frequency) of each morpheme by referring to a list of morphemes (nouns) of each sentence stored in the RAM 12 and the number of times of appearance thereof and adding numbers of times of appearance for each morpheme (step S301), The C1PU 11 removes the morphemes of which the total appearance frequency is less than a reference lower limit value or larger than a reference upper limit value (step S302),

The CPU 11 generates all the sets of morphemes that appear simultaneously in each predetermined range (each sentence) for the remaining; morphemes and obtains the total (total co-occurrence frequency) for all the predetermined ranges for each set (step S303). As described above, the appearance frequency of the set of morphemes appearing several times within a predetermined range is the appearance frequency of the morpheme having the lower appearance frequency among the two morphemes forming the set. The CPU 11 removes a set of morphemes of which the total co-occurrence frequency is less than a threshold value (step S304).

The CPU 11 calculates the Simpson coefficient for each of the remaining sets of morphemes for which the total co-occurrence frequency is obtained, based on the total co-occurrence frequency and the total appearance frequency of each morpheme (step S305). The CPU 11 removes a set of morphemes of which the Simpson coefficient is less than the lower limit value (step S306), The CPU 11 stores and retains the co-occurrence information (including at least the total co-occurrence frequency and the Simpson coefficient) of the remaining set of morphemes in the RAM 12 (step S307). Then, the CPU 11 ends the co-occurrence analysis control process.

The processes of steps S301 and S302 may be included in the analysis data acquisition control process. Further, the processes related to the filtering in steps S302, S304, and the like may be collectively executed after the analysis processes in steps S303, S305, and the like are performed.

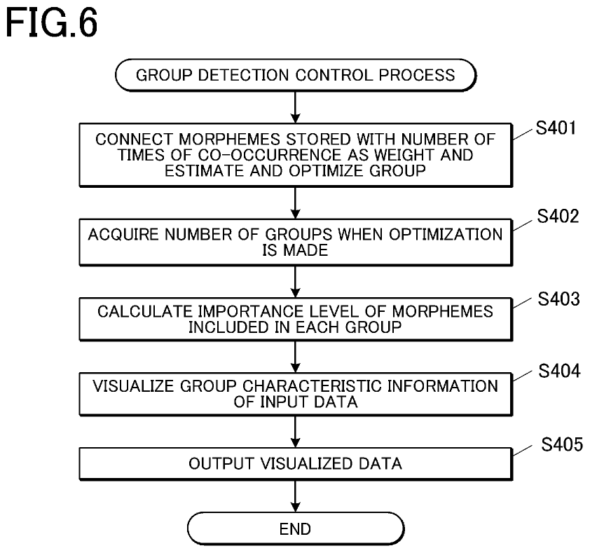

FIG. 6 is a flowchart illustrating a control procedure of a group detection control process by the CPU 11. The content of the group detection control process corresponds to the processes of the generation unit B4 and the output unit B5 described above and starts after the co-occurrence analysis control process is completed.

When the group detection control process starts, the CPU 11 connects the remaining morphemes stored in the RAM 12 with the number of times of co-occurrence as a weight (which can be expressed as a matrix as a whole) and estimates and optimizes the group by using the Louvain method (step S40), The CPU 11 acquires the number of groups when the optimization is made (step S402).

The CPU 11 calculates the importance level of the morphemes included in each group by, for example, the mediation centrality (step S403).

The CPU 11 generates the visualized data of group characteristic information (characteristic information) of the input data (step S404). In addition to the abovementioned number of groups, the group characteristic information includes, for example, information on morphemes belonging to each group with a high importance level (some features). The CPU 11 outputs the visualized data to the display 16 or the like (step S405). Then, the CPU 11 ends the group detection control process.

The information on the appropriate number of groups obtained in this manner can be used as an input (initial setting) for the classification process according to another document classification method. For example, even when documents are classified by using latent Dirichlet allocation (LDA), the obtained number of groups can be initially set as the number of clusters.

The control contents of the analysis data acquisition control process, the co-occurrence analysis control process, and the group detection control process described above are included in the program 131, but these control contents may be completely independent or may depend on each other to allow the temporary data or the like automatically stored in the RAM 12 to be transferred. In addition, as described above, when the order of the processes is changed or the processes are performed in parallel, the plurality of processes are executed in parallel or after a portion of process contents are executed, the remaining process contents may be executed after waiting for the required result with other processes.

As described above, the information processing device 1 according to the embodiment includes the CPU 11. The CPU 11 as an extractor extracts the plurality of features (morphemes) related to the content of the acquired input data. The CPU 11 as an analyzer analyzes the co-occurrence relationship between the extracted plurality of features (morphemes). The CPU 11 as a generator generates a group (community) related to a plurality of features (morphemes) based on the co-occurrence relationship.

In this manner, once the group is automatically generated by using the co-occurrence relationship, the information processing device 1 can specify the number of groups suitable for classification of digital information from the generated number of groups. By classifying the data with the specified number of groups as the initial setting, it is possible to suppress the situation where a plurality of main topics are included in the same group and are not properly separated. Further, only by repeating such a process at an appropriate interval, re-classification can be performed easily in response to an increase or decrease in the number of groups due to changes in the data contents over time. In addition, by performing appropriate classification again by using only the number of groups obtained in the embodiment, the classification can be performed according to the classification criteria suitable for the sense of the user, and so that the user can perform easily the searching of the user.

The input data that becomes the classification target is at least one of document data, image data, and audio data. When the input data is such data, the data can be easily converted into a text, and the features can be extracted.

Further, the CPU 11 as a converter converts the input data into data in a predetermined format (for example, a text format) from which features can be easily extracted. The CPU 11 as an extractor extracts a plurality of features (morphemes) from the converted data. By unifying the data into the common predetermined format and then extracting the features in this manner, the subsequent processes can be unified. In addition, by arranging the feature extraction methods, it is possible to extract features from the input data based on the same criteria, and it is possible to suppress unnecessary variation in determination in the group estimation.

Further, when the input data is in a predetermined format (text data) from the beginning, the CPU 11 as a converter may use the input data as it is as the converted data. That is, in this case, no particular conversion process is required, and it is not necessary to take time and effort.

Further, the predetermined format is a text format, the CPU 11 as a segmenter segments the converted data into morphemes by the morpheme analysis specifies the part of speech of the segmented morphemes, respectively, and the CPU 11 as an extractor extracts at least a portion of the morphemes as a feature. That is, in the information processing device 1, since the content is determined in a word base from the text, an arrangement order, dependency, and the like of words need not to be considered, and the process becomes easy. In addition, the amount of data can be reduced by using text data.

Further, the CPU 11 as an extractor extracts nouns as a plurality of features among the morphemes segmented by the morpheme analysis. Since a lot of nouns correspond to the content of the text and it is easier to reduce noise than verbs and adjectives, by narrowing down the extraction to nouns, the features can be extracted appropriately without disturbing the content while reducing processing.

In addition, the nouns include proper nouns. Since proper nouns such as person names, place names, and product names are often closely related to the topic, the classification becomes more accurate by making the proper nouns properly extractable, and as a result, the appropriate number of groups can be obtained more accurately.

Further, the CPU 11 as an extractor acquires the appearance frequency of a plurality of extracted features (morphemes) in the divided data in which the input data is divided for each predetermined range (for example, one sentence), and the CPU 11 as an analyzer counts and acquires the co-occurrence frequency of each combination of features (morphemes) that appear simultaneously in the divided data and obtains the strength of the co-occurrence relationship between the features based on the appearance frequency and co-occurrence frequency (by the total appearance frequency which is the total for each features and the total co-occurrence frequency which is the total for each set of features). That is, in the process of the analyzer, the directionality of the combination is not taken into consideration, so that the processing is easy. In addition, since the word connection is considered by the co-occurrence relationship, the bias of the word according to the content can be appropriately reflected.

Further, the predetermined range may be a single sentence, a set number of sentences, a single paragraph, or a single document. Since the predetermined range defines the range in which the co-occurrence relationship can be appropriately determined, the predetermined range may not straddle a portion where the content changes.

Further, the CPU 11 as an analyzer filters the features that are analysis targets based on the appearance frequency (herein, by the total). Some words include universal nouns and abstract nouns and, thus, do not always reflect the content. Since a lot of such words appear without limitation of the content, a more appropriate relationship between the contents and the words can be easily obtained by appropriately excluding these words based on the appearance frequency. On the other hand, the words that appear exceptionally with a low appearance frequency may be excluded because certainty and accuracy are statistically insufficient to obtain a connection with other features (words) as features. Due to these processes, more accurate and less noisy analysis can be performed by using only appropriate words that appear at the appearance frequency required for analysis.

Further, the CPU 11 as an analyzer excludes the features of which the total of appearance frequencies (total appearance frequency) is not, within the reference range from the analysis target. As described above, by excluding the words other than those within the reference range in which the appearance frequency is not too high and not too low, the words that are noisy for the process related to the subsequent group detection are appropriately excluded, so that the detection accuracy of the group can be improved.

Further, the CPU 11 as an analyzer excludes a combination of features of which strength (Simpson coefficient) of the relationship obtained as described above does not reach the minimum reference from the analysis target. That is, the set of words that do not appear simultaneously within a predetermined range or the set of words that appear simultaneously at a low rate may be excluded from the analysis target. Since such a set of words do not appear simultaneously within a predetermined range that is biased according to the content, it is considered that the set of words are not very useful for classifying the content. Therefore, by excluding, such a set of words in advance, it is possible to reduce the labor of the, group detection process and improve the accuracy thereof.

Further, the CPU 11 as a generator determines a group based on the degree of aggregation (cohesion degree) of features according to the distribution of the strength of the co-occurrence relationship among the features obtained by the analyzer. In this manner, since the group is determined by the connection of features (words) included in the input data, it is easy to evaluate the content, and since the groups are appropriately merged and separated according to the sparseness of the connection of features (words), it is possible to obtain an appropriate number of groups.

Further, the CPU 11 as a generator determines the group so as to optimize a predetermined index (Simpson coefficient) for evaluating the quality of the aggregation. Since the determination of sparseness is performed numerically by using an index, the user or the like need not perform the determination based on subjectivity or the like, and the process can be easily completed.

Further, the CPU 11 as a generator determines the group by using the Louvain method. By weighting the co-occurrence relationship according to the appearance frequency of simultaneous appearance by using the method, the sparseness of the aggregation between the features is appropriately determined, and the optimum number of groups and the partitions can be obtained by asymptotically approaching to the optimum solution.

Further, the CPU 11 as a generator calculates the importance level (mediation centrality or the like) of the feature based on the relationship of the feature belonging to the determined group to other features in the group and associates the calculated importance level with a group in which some relatively high features can be obtained. By generating output data such that not only the appropriate number of groups but also what kind of features (words) are actually included can be indicated, the information processing device 1 can indicate results to the user in an easy-to-understand manner, and the users can use the results more effectively.

Further, the information processing device 1 includes a storage unit 13 that stores the determined group and some features associated with the group. By retaining the obtained results, when the results are obtained again with the input data updated later and output, it is possible to provide information to the user while comparing with the previous output results.

Further, the CPU 11 as an output unit outputs the determined group and the group characteristic information. As a result, the user can directly acquire reference information related to the classification of data including an appropriate number of groups from the information processing device 1.

Further, the CPU 11 as an output data generator generates visualized data for visualizing the group and characteristic information of the group, and the CPU 11 as an output unit outputs and visualizes the generated visualized data to the display 16 for outputting an image.

That is, since the information processing device 1 can allow the user to visually recognize the result as display data, the user can obtain the required information more easily and intuitively.

Alternatively, the information processing system according to the embodiment includes the CPU 11, The CPU 11 extracts a plurality of features (morphemes) related to the content of the acquired input data as an extractor, and analyzes a co-occurrence relationship between the extracted plurality of features (morphemes) as an analyzer, and generates a group (community) related to a plurality of features (morphemes) based on the co-occurrence relationship as a generator.

That is, even in a system in which CPUs 11 are distributed to a plurality of computers and a group is generated by executing the assigned processes, the information related to the number of classifications for appropriately classifying the input data of the classification target described above can be obtained. In addition, by appropriately assigning processes according to the capacity of each CPU 11, the amount of input data, other processes or the like executed in parallel, the processing time can be suppressed from becoming long and the processing load from being concentrated.

Further, the information processing method according to the embodiment includes extracting a plurality of features (morphemes) related to contents of acquired input data, analyzing a co-occurrence relationship between the extracted plurality of features, and generating a group of the plurality of features based on the obtained co-occurrence relationships. According to such an information processing method, once the groups are automatically generated by using the co-occurrence relationship, the number of groups suitable for classification of digital information can be specified from the number of generated groups. By classifying the data with the specified number of groups as the initial setting, it is possible to suppress the state where the main topics are included in the same group and are not properly separated.

Further, by executing each of the above-described processes by the program 131 of the embodiment, an appropriate number of groups for the input data of the classification target can be easily obtained by software in a computer having no special dedicated hardware.

The invention is not limited to the above-described embodiment, and various types of modifications can be made. For example, in the above-described embodiment, it is described that all the data is once converted into the text data, and the morpheme analysis is performed to extract nouns , but except for document data, conversion into a combination of only the plurality of nouns is performed at the beginning, so that the morpheme analysis may be omitted.

Further, in the above-described embodiment, the case where words are segmented into all the words and used as morphemes in the morpheme analysis is described, but the invention is not limited thereto. The word expressed by a combination of the plurality of words may not be segmented into individual words.

Further, the language of the input data and the converted text data is not particularly limited. Also, the document does not have to be limited to documents in a single language. However, even when a plurality of languages are mixed, it is preferable that morphemes (words) having the same meaning are processed so as to be treated as the same.

In addition, the data format of the text data to be converted is not particularly limited, but it is preferable that the data format be unified. That is, when the text data has a plurality of formats, the conversion process into a predetermined unified format may be performed. The converted data may be, for example, simple plain text data or may be data in various types of formats such as a json format and an XML format. Alternatively, proprietary binary format data may be used.

On the other hand, the features may be extracted separately without unifying the formats. If the expression of the feature is in a unified format, the subsequent processes can be performed in the same manner as in the above-described embodiment.

Further, the obtained result does not necessarily have to be stored in the storage unit 13. The result may be stored in the RAM 12 only as long as necessary for output and may be erased after each output of the result.

Further, in the above-described embodiment, not only the number of obtained groups but also the characteristic information of the group is output together, but if the number of groups is output, other characteristic information and the like may not be output.

Further, in the above-described embodiment, the case where the document data, the image data, or the audio data is input is described, but other than these data may be included. For example, a three-dimensional structure that can be appropriately converted into text data may be included.

Further, for example, instead of converting the, image data into the text data and then partitioning the text data within a predetermined range, the image data may be divided into a plurality of ranges and then may be converted into the text data in each predetermined range.

Further, in the above-described embodiment, when the total appearance frequency and the total co-occurrence frequency do not satisfy the criteria, it is described that the morpheme and the combination of the morphemes are excluded, respectively, but this criterion may be adjusted as appropriate. Also, some criteria may not be used.

Further, in the above-described embodiment, the filtering of the strength of the co-occurrence relationship is performed by using the total appearance frequency and the total co-occurrence frequency, but the invention is not limited thereto. For example, when the lengths of the predetermined ranges are substantially the same, the average appearance frequency or the average co-occurrence frequency for each predetermined range may be used, or when the Lengths of the predetermined ranges are non-uniform, a weighted average appearance frequency or a weighted co-occurrence frequency with weighting according to the length performed may be used. Further, the weighting may be determined not only according to the length in a predetermined range but also according to the size of the relative font sizes in the document, the font (bold font or the like), and the like.

Further, in the above-described embodiment, among the morphemes, only nouns are extracted and used, but extraction of other parts of speech, for example, adjectives and verbs is not uniformly excluded. Further, when a part of speech other than a noun is used, the criteria of the total appearance frequency and the total co-occurrence frequency may be different from those of nouns and between nouns. For example, only verbs and adjectives that have particularly high relationship (Simpson coefficient or the like) with respect to nouns may be extracted. In this case, terms including declension of adjectives, verbs, and the, like may be used uniformly in the basic form. Similarly, the nouns may be unified into a basic form such as a singular form.

Further, in the above description, ate storage unit 13 made of a non-volatile memory such as an HDD or a flash memory is exemplified and described as a computer-readable medium for storing the program 131 related to the detection control of the number of groups of the invention, but the invention is not limited thereto. As other computer-readable media, other non-volatile memories such as MRAMs and portable recording media such as CD-ROMs and DVD discs can be applied. Further, as a medium for providing the data of the program according to the invention via a communication line, a carrier wave is also applied to the invention.

In addition, the specific configuration and the content and procedure of the processing operation illustrated in the above-described embodiment can be appropriately changed without departing from the spirit of the invention. The scope of the invention includes the scope of the invention described in the claims and the equivalent scope thereof.

What is claimed is:

1. An information processing device comprising:
a hardware processor that:
extracts a plurality of features related to a content of acquired first data;
analyzes a co-occurrence relationship between the plurality of features; and
generates a group related to the plurality of features based on the co-occurrence relationship.

2. The information processing device according to claim 1,
wherein the first data is at least one of document data, image data, and audio data.

3. The information processing device according to claim 1,
wherein the hardware processor:
converts the first data into second data in a predetermined format from which the plurality of features are capable of being extracted; and
extracts the plurality of features from the second data.

4. The information processing device according to claim 3,
wherein the first data is in the predetermined format, and
wherein the hardware processor sets the first data as it is as the second data.

5. The information processing device according to claim 3,
wherein the predetermined format is a text format, and
wherein the hardware processor:
segments the second data into morphemes by morpheme analysis;
specifies parts of speech of the morphemes; and
extracts at least a portion of the morphemes as the plurality of features.

6. The information processing device according to claim 5,
wherein the hardware processor extracts a noun among the morphemes as the plurality of features.

7. The information processing device according to claim 6,
wherein the noun includes a proper noun.

8. The information processing device according to claim 1,
wherein the hardware processor:
acquires a first appearance frequency of the plurality of features extracted in divided data obtained by dividing the first data for each predetermined range;
counts and acquires a second appearance frequency of each of combinations of features among the plurality of features that appear simultaneously in the divided data; and
obtains a strength of the co-occurrence relationship between the features based on the first appearance frequency and the second appearance frequency.

9. The information processing device according to claim 5,
wherein the hardware processor:
acquires a first appearance frequency of the plurality of features obtained by segmenting the second data into morphemes in divided data obtained by dividing the second data for each predetermined range;
counts and acquires a second appearance frequency of each of combinations of features among the plurality of features that appear simultaneously in the divided data; and
obtains a strength of the co-occurrence relationship among the features based on the first appearance frequency and the second appearance frequency,
wherein the predetermined range is one of a single sentence, a set number of sentences, a single paragraph, and a single document.

10. The information processing device according to claim 8,
wherein the hardware processor:
filters the features based on the first appearance frequency; and
extracts a feature as an analysis target among the ⁻features.

11. The information processing device according to claim 10,
wherein the hardware processor filters out a feature of which a total of the first appearance frequency is not within a reference range among the features from the analysis target.

12. The information processing device according to claim 10,
wherein the hardware processor filters out a combination of the features of which the strength of the co-occurrence relationship does not reach a minimum reference from the analysis target.

13. The information processing device according to claim 8,
wherein the hardware processor determines the group based on a degree of aggregation of the features according to a distribution of the strength of the co-occurrence relationship between the features.

14. The information processing device according to claim 13,
wherein the hardware processor determines the group so as to optimize a predetermined index for evaluating a quality of the aggregation.

15. The information processing device according to claim 13,
wherein the hardware processor determines the group by using a Louvain method.

16. The information processing device according to claim 13,
wherein the hardware processor:
calculates an importance level of the features based on the relationship of the features belonging to the group that has been determined to other features in the group; and
associates a portion of the features of which the importance level is a relatively high with the group.

17. The information processing device according to claim 16, further comprising:
a storage that stores the group that has been determined and the portion of the features,

18. The information processing device according to claim 16,
wherein the hardware processor outputs the group that has been determined and characteristic information of the group.

19. The information processing device according to claim 18,
wherein the hardware processor:
generates visualized data visualizing the group and the characteristic information of the group; and
outputs and visualizes the visualized data to a display that outputs an image, 20, An information processing system comprising:
one or more hardware processors, one of the one or more hardware processors extracting a plurality of features related to a content of acquired first data, one of the one or more hardware processors analyzing a co-occurrence relationship between the extracted plurality of features, and one of the one or more hardware processors generating a group of the plurality of features based on the co-occurrence relationship.

21. An information processing method comprising:
extracting a plurality of features related to a content of acquired first data;
analyzing a co-occurrence relationship between the plurality of features; and
generating a group related to the plurality of features based on the co-occurrence relationship:

22. A non-transitory storage medium storing a computer readable program, the program causing a computer to execute functions of:
extracting a plurality of features related to a content of acquired first data;
analyzing a co-occurrence relationship between the plurality of features; and
generating a group related to the plurality of features based on the co-occurrence relationship.
